(19) United States
(12) Patent Application Publication
(10) Pub. No.: US 2024/0305381 A1
(43) Pub. Date: Sep. 12, 2024

(54) MODULATING RETROREFLECTOR HAVING SERIES-COUPLED MODULATING COMPONENTS

(71) Applicant: Raytheon Company, Tewksbury, MA (US)

(72) Inventors: Andrew M. Kowalevicz, Arlington, VA (US); Gary M. Graceffo, Burke, VA (US); James Talamonti, McLean, VA (US)

(21) Appl. No.: 18/424,591

(22) Filed: Jan. 26, 2024

Related U.S. Application Data
(60) Provisional application No. 63/488,919, filed on Mar. 7, 2023.

(51) Int. Cl. H04B 10/516; G02B 5/122; G02F 1/03; G02F 1/055; H04B 10/11

(52) U.S. Cl. CPC H04B 10/516; G02F 1/0311; G02F 1/055; H04B 10/11; G02B 5/122; G02F 2203/02

(57) ABSTRACT

A system includes a modulating retroreflector. The modulating retroreflector includes one or more reflective surfaces configured to receive an optical signal and to provide a reflected optical signal. The modulating retroreflector also includes multiple modulators configured to modulate the optical signal and encode data onto the optical signal such that the reflected optical signal represents a reflected and modulated version of the optical signal. The multiple modulators are electrically connected in series. The system also includes a control circuit configured to generate a drive signal and to provide the drive signal to the multiple modulators in order to control the encoding of the data onto the optical signal.

### CROSS-REFERENCE TO RELATED APPLICATION AND PRIORITY CLAIM

This application claims priority under 35 U.S.C. § 119(e) to U.S. Provisional Patent Application No. 63/488,919 filed on Mar. 7, 2023. This provisional application is hereby incorporated by reference in its entirety.

### TECHNICAL FIELD

This disclosure is generally directed to optical systems. More specifically, this disclosure is directed to a modulating retroreflector having series-coupled modulating components.

### BACKGROUND

Free-space optical systems generally include optical nodes that communicate or that otherwise transmit/receive light through free space rather than through fiber optic cables or other physical cables. In some free-space optical systems or other systems, a first optical node can be used to transmit optical signals towards a second optical node, where the second optical node includes a retroreflector. The retroreflector in the second optical node reflects the optical signals back towards the first optical node, which can receive and process the reflected optical signals.

### SUMMARY

This disclosure is directed to a modulating retroreflector having series-coupled modulating components.

In a first embodiment, an apparatus includes a modulating retroreflector. The modulating retroreflector includes one or more reflective surfaces configured to receive an optical signal and to provide a reflected optical signal. The modulating retroreflector also includes multiple modulators configured to modulate the optical signal and encode data onto the optical signal such that the reflected optical signal represents a reflected and modulated version of the optical signal. The multiple modulators are electrically connected in series.

In a second embodiment, a system includes a modulating retroreflector. The modulating retroreflector includes one or more reflective surfaces configured to receive an optical signal and to provide a reflected optical signal. The modulating retroreflector also includes multiple modulators configured to modulate the optical signal and encode data onto the optical signal such that the reflected optical signal represents a reflected and modulated version of the optical signal. The multiple modulators are electrically connected in series. The system also includes a control circuit configured to generate a drive signal and to provide the drive signal to the multiple modulators in order to control the encoding of the data onto the optical signal.

In a third embodiment, a method includes receiving an optical signal at a modulating retroreflector. The method also includes reflecting the optical signal using the modulating retroreflector, where the modulating retroreflector includes one or more reflective surfaces configured to receive the optical signal and to provide a reflected optical signal. The method further includes encoding data onto the optical signal, where the modulating retroreflector further includes multiple modulators configured to modulate the optical signal and encode the data onto the optical signal such that the reflected optical signal represents a reflected and modulated version of the optical signal. The multiple modulators are electrically connected in series.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example optical system supporting a modulating retroreflector having series-coupled modulating components according to this disclosure;

FIGS. 2A through 2C illustrate example corner-cube modulating retroreflectors having series-coupled modulating components according to this disclosure;

FIGS. 3A through 3C illustrate example cat's eye modulating retroreflectors having series-coupled modulating components according to this disclosure;

FIG. 4 illustrates an example arrangement for controlling a modulating retroreflector having series-coupled modulating components according to this disclosure; and

FIG. 5 illustrates an example method for using a modulating retroreflector having series-coupled modulating components according to this disclosure.

### DETAILED DESCRIPTION

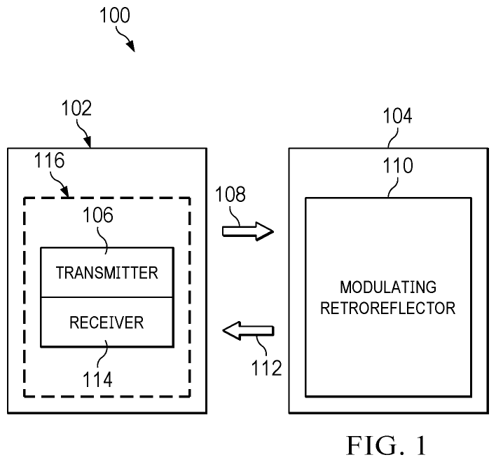

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, free-space optical systems generally include optical nodes that communicate or that otherwise transmit/receive light through free space rather than through fiber optic cables or other physical cables. In some free-space optical systems or other systems, a first optical node can be used to transmit optical signals towards a second optical node, where the second optical node includes a retroreflector. The retroreflector in the second optical node reflects the optical signals back towards the first optical node, which can receive and process the reflected optical signals. In some cases, the retroreflector in the second optical node may be used to impart intensity modulations to the optical signals being reflected. This allows the second optical node to encode data for transmission using the reflected optical signals. The first optical node can receive the reflected optical signals and recover the encoded data based on the intensity modulations contained in the reflected optical signals.

While modulating retroreflectors can represent low-cost, low-power, low-complexity solutions to enable functions such as free-space optical communications, there are significant limitations on the data rates (speeds) and ranges (distances) of those optical communications. For instance, some retroreflectors supporting intensity modulations may allow for data rates of only around twenty megabits per second at a range of only several hundred meters. Smaller aperture sizes may be used to increase data rates for optical communications, but smaller aperture sizes typically reduce the effective ranges of the optical communications. Also, some modulating retroreflectors may incorporate multiple quantum wells (MQWs) to perform intensity modulations, but it is generally not practical to use quantum wells in multiple distinct components of a retroreflector due to high insertion losses associated with the quantum wells. As a result, quantum wells may be used on only one reflective or transmissive surface or other component of a retroreflector in order to avoid multiple high insertion losses in the optical pathway. Moreover, modulating retroreflectors based on quantum wells are often limited to narrow wavelength ranges, such as wavelength ranges spanning about 30 nanometers. In addition, modulating retroreflectors that support intensity modulations often use larger surfaces and higher control voltages to provide the intensity modulations, which can generate significant amounts of thermal energy that need to be removed.

This disclosure provides various modulating retroreflectors having series-coupled modulating components (also referred to as series-coupled modulators). As described in more detail below, a modulating retroreflector can include multiple controllable modulating components, such as multiple controllable reflective surfaces, multiple controllable layers of optically-transparent material, or a combination of one or more controllable reflective surfaces and one or more controllable layers of optically-transparent material. Each controllable modulating component can be used to provide phase, amplitude, intensity, polarization, or other modulations of optical signals being reflected from or transmitted through the controllable modulating component of the modulating retroreflector. Also, the controllable modulating components are electrically coupled in series, which means that each controllable modulating component is electrically coupled in series with a preceding controllable modulating component, a subsequent controllable modulating component, or both.

Each controllable modulating component typically has an associated capacitance. The capacitance of a single large modulating component can be relatively high, which can result in lower modulation rates and therefore slower data rates. By coupling multiple controllable modulating components of a modulating retroreflector in series, the overall capacitance of the controllable modulating components may decrease, or multiple larger controllable modulating components may be used while achieving the same or similar overall capacitance. Because the capacitance is effectively reduced, the overall speed for a given-size modulator can be increased. It is also possible to increase the size of the modulator (since capacitance scales with the area of the modulator) while keeping the modulation rate the same, thus increasing the range of the modulator. Further, the decreased capacitance may be used to increase both the range (but not as far as otherwise possible) and the rate (but not as much as otherwise possible). Note that these potential benefits are independent of the fact that lower insertion losses may be obtained in comparison to MQW designs, which would also increase the range. As a result, this can help to increase the fundamental modulation rate and thereby increase the data rate that are achievable using the modulating retroreflector and/or increase the effective range of the modulating retroreflector and allow for larger link ranges to be achieved compared to equivalently-sized devices. In addition, in some embodiments, one or more materials may be selected and used in or with the controllable modulating components of a modulating retroreflector, where the one or more materials can require lower voltages for performing phase, amplitude, intensity, polarization, or other modulations (compared to traditional materials). This can result in reduced power consumption and therefore reduced thermal energy generation, which can simplify power supply and thermal management issues with modulating retroreflectors. Overall, the described approaches can allow modulating retroreflectors to be designed with equivalent fields of regard and with larger collection areas while achieving improved data rates and ranges. In some cases, this can be achieved over a wide range of wavelengths and/or using multiple levels of modulations if needed or desired.

FIG. 1 illustrates an example optical system 100 supporting a modulating retroreflector having series-coupled modulating components according to this disclosure. As shown in FIG. 1, the optical system 100 includes two nodes 102 and 104. Each node 102 and 104 represents a ground-, air-, or space-based system that can communicate or otherwise interact optically. In this example, the node 102 includes an optical transmitter 106, which generally operates to produce optical signals 108 used for communication or other purposes. For example, the optical transmitter 106 may represent a laser or other optical source that can generate the optical signals 108 for transmission towards the node 104.

The node 104 includes a modulating retroreflector 110, which receives the optical signals 108 from the node 102 and reflects the optical signals 108 back towards the node 102 as reflected optical signals 112. The modulating retroreflector 110 is also configured to provide phase, amplitude, intensity, polarization, or other modulations to the optical signals 108 in order to encode data onto the reflected optical signals 112. For example, the data encoded onto the reflected optical signals 112 may include identification information identifying the node 104 and/or data collected or otherwise obtained by the node 104. Note, however, that the node 104 may encode any other or additional data onto the reflected optical signals 112. Also note that the modulating retroreflector 110 may perform any suitable modulation technique or combination of modulation techniques to encode data onto the reflected optical signals 112.

As described in more detail below, the modulating retroreflector 110 includes multiple controllable modulating components, such as multiple controllable reflective surfaces, multiple controllable layers of optically-transparent material, or a combination of one or more controllable reflective surfaces and one or more controllable layers of optically-transparent material. The controllable modulating components are used to create the phase, amplitude, intensity, polarization, or other modulations that are contained in the reflected optical signals 112. The controllable modulating components are also electrically coupled together serially, which can help to reduce the overall capacitance of the controllable modulating components or allow larger controllable modulating components to be used while achieving the same or similar overall capacitance. In addition, in some cases, one or more of the controllable modulating components may include or contain one or more materials that are selected to enable modulation control using lower voltages and with lower losses. The lower losses can allow the multiple controllable modulating components to be implemented or used at multiple locations in an optical pathway without significantly compromising the system's overall performance.

The node 102 further includes an optical receiver 114 that receives the reflected optical signals 112 and decodes the modulations contained in the reflected optical signals 112 in order to recover the data from the reflected optical signals 112. Any suitable type(s) of modulation/demodulation scheme or schemes may be used here to encode and decode optical signals. In some cases, the optical receiver 114 may represent an etalon-based receiver, which can allow for end-to-end low size, weight, power, and cost (SWAP-C) free-space communications when using complex modulation without adaptive optics. Note that while the optical transmitter 106 and the optical receiver 114 are shown here as separate components, they can be integrated into a single optical transceiver 116 (which may be referred to as an interrogator in some cases). This may allow, for example, the same structure to be used for both transmission and reception purposes.

The nodes 102 and 104 here may find use in a large number of applications. For example, the nodes 102 and 104 may be used to support optical communications in various terrestrial and space-based applications, including applications that involve overt and/or covert data transfers. As particular examples, the nodes 102 and 104 may be used to support backhaul optical communications in 5G networks or other telecommunications networks or to support ship-to-shore or other ship-based communications. As other particular examples, the nodes 102 and 104 may be used to support optical communications for data exfiltration from disadvantaged platforms like micro-satellites and unmanned aerial vehicles (UAVs). As yet another particular example, the nodes 102 and 104 may be used to support point-to-point optical communications for various purposes. Note, however, that this disclosure is not limited to any particular application of the nodes 102 and 104 or the described modulating retroreflectors.

Although FIG. 1 illustrates one example of an optical system 100 supporting a modulating retroreflector having series-coupled modulating components, various changes may be made to FIG. 1. For example, while only two nodes 102 and 104 are shown here, the optical system 100 may include any suitable number of nodes that engage in any suitable optical communications or other optical interactions with each other. Also, the optical system 100 is shown in simplified form here and may include any number of additional components in any suitable configuration as needed or desired.

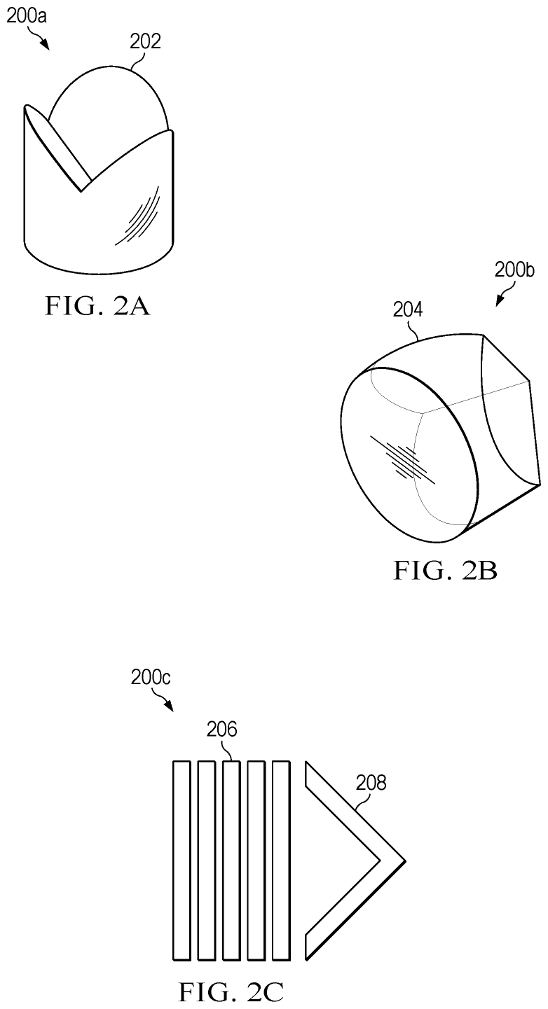

FIGS. 2A through 2C illustrate example corner-cube modulating retroreflectors 200a-200c having series-coupled modulating components according to this disclosure. Each of the modulating retroreflectors 200a-200c may, for example, represent a possible implementation of the modulating retroreflector 110 in the node 104 of FIG. 1. However, each of the modulating retroreflectors 200a-200c may be used in any other suitable device(s) and in any other suitable system(s).

As shown in FIG. 2A, the modulating retroreflector 200a represents a hollow retroreflector having three reflective surfaces 202. The reflective surfaces 202 are arranged in order to reflect light back in the same or similar direction that the light is received. As shown in FIG. 2B, the modulating retroreflector 200b represents a solid retroreflector having four reflective surfaces 204. Again, the reflective surfaces 204 are arranged in order to reflect light back in the same or similar direction that the light is received. As shown in FIG. 2C, the modulating retroreflector 200c represents a stacked or other arrangement in which multiple layers 206 of optically-transparent material are positioned in front of a right-angle reflector having multiple reflective surfaces 208. Once again, the reflective surfaces 208 are arranged in order to reflect light back in the same or similar direction that the light is received. Thus, each modulating retroreflector 200a, 200b, or 200c (if used as the modulating retroreflector 110 in the node 104 of FIG. 1) would reflect the optical signals 108 received from the node 102 back towards the node 102.

In FIGS. 2A through 2C, two or more of the reflective surfaces 202, 204, 208 of each modulating retroreflector 200a-200c may be implemented as controllable modulating components. For example, two or more of the reflective surfaces 202, 204, 208 may be designed to be controlled so as to impart phase, amplitude, intensity, polarization, or other modulations to optical signals being reflected by the reflective surfaces 202, 204, 208. Also or alternatively, in FIG. 2C, two or more of the layers 206 of the modulating retroreflector 200c may be implemented as controllable modulating components. For instance, two or more of the layers 206 may be designed to be controlled so as to impart phase, amplitude, intensity, polarization, or other modulations to optical signals being transmitted or passing through the layers 206. A combination of approaches may also be used, such as when one or more of the reflective surfaces 202, 204, 208 and one or more of the layers 206 may be implemented as controllable modulating components. In general, each of the modulating retroreflectors 200a-200c can include multiple controllable modulating components, where two or more of the controllable modulating components are electrically coupled in series.

Note that while the layers 206 of optically-transparent material are positioned in front of a right-angle reflector in FIG. 2C, the same or similar type of arrangement may be used in FIGS. 2A and 2B. Thus, for example, the modulating retroreflectors 200a-200b in FIGS. 2A and 2B may include the layers 206 of optically-transparent material positioned in front of the reflective surfaces 202, 204 of the modulating retroreflectors 200a-200b. In these embodiments, each of the modulating retroreflectors 200a-200b can have multiple controllable modulating components, whether those controllable modulating components include one or more reflective surfaces 202 or 204, one or more layers 206 of optically-transparent material, or both. Also note that while the layers 206 of optically-transparent material are shown here as being separate from the right-angle reflector in FIG. 2C, the layers 206 of optically-transparent material may be formed directly or indirectly on any of the reflective surfaces 202, 204, 208 of each modulating retroreflector 200a-200c. For instance, the layers 206 of optically-transparent material may be formed as thin film layers on any of the reflective surfaces 202, 204, 208.

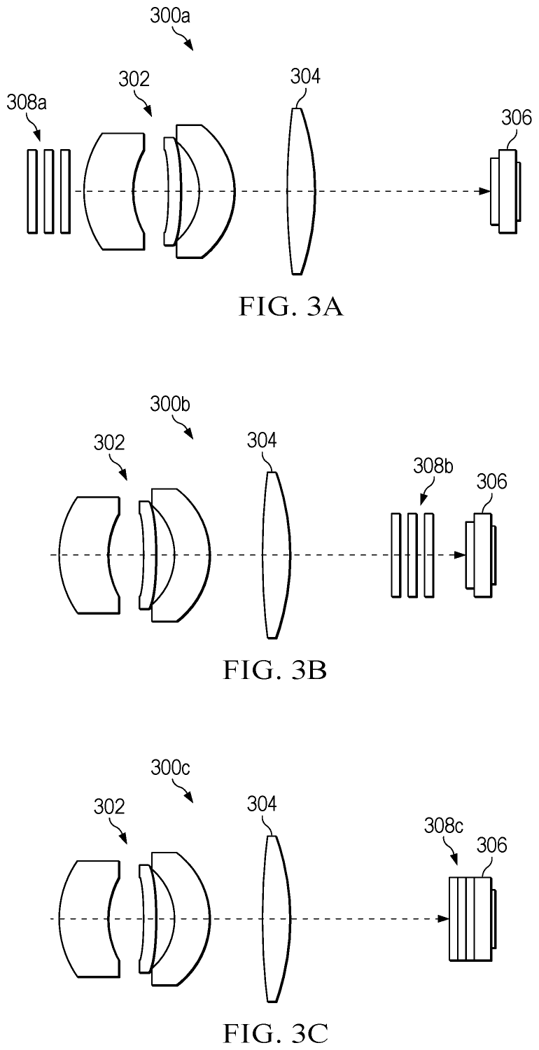

FIGS. 3A through 3C illustrate example cat's eye modulating retroreflectors 300a-300c having series-coupled modulating components according to this disclosure. Each of the modulating retroreflectors 300a-300c may, for example, represent a possible implementation of the modulating retroreflector 110 in the node 104 of FIG. 1. However, each of the modulating retroreflectors 300a-300c may be used in any other suitable device(s) and in any other suitable system(s).

As shown in FIGS. 3A through 3C, each modulating retroreflector 300a-300c represents a cat's eye retroreflector that includes a set of optics 302, which are used to modify light passing through the optics 302. A lens 304 focuses the light onto a reflective surface 306, which reflects the light back through the lens 304 and the optics 302. In this example, the combination of the convex, concave, and flat surfaces of the optics 302, lens 304, and reflective surface 306 cooperate to reflect light back in the same or similar direction that the light is received. Note that this arrangement represents one example of how optical devices can be used to form a cat's eye retroreflector, but other configurations of optical devices may be used. For instance, some designs for cat's eye retroreflectors use a concave reflective surface 306 rather than a planar reflective surface 306 as shown here.

Each modulating retroreflector 300a-300c also respectively includes a stacked arrangement in which multiple layers 308a-308c of optically-transparent material are positioned within the optical pathway of the modulating retroreflector 300a-300c. In some cases, two or more of the layers 308a-308c in each modulating retroreflector 300a-300c may be implemented as controllable modulating components. For instance, two or more of the layers 308a-308c may be designed to be controlled so as to impart phase, amplitude, intensity, polarization, or other modulations to optical signals being transmitted or passing through the layers 308a-308c.

In these particular examples, the layers 308a are positioned in front of the optics 302 of the modulating retroreflector 300a, the layers 308b are positioned between the lens 304 and the reflective surface 306 of the modulating retroreflector 300b, and the layers 308c are positioned on or proximate to the reflective surface 306 of the modulating retroreflector 300c. In each case, the two or more layers 308a-308c representing controllable modulating components can be used to provide modulations to the optical signals. Note, however, that these positions for the layers 308a-308c are examples only. In general, each of the modulating retroreflectors 300a-300c can include multiple controllable modulating components in any suitable location or locations, where two or more of the controllable modulating components are electrically coupled in series.

In some embodiments, one or more of the reflective surfaces 202, 204, 208, 306 and/or one or more of the layers 206, 308a-308c representing the controllable modulating components can be formed by or include at least one of a ferroelectric ceramic, such as lead lanthanum zirconate titanate (PLZT), or a dielectric ceramic, such as barium titanium (BaTi). In particular embodiments, the ferroelectric or dielectric ceramic can be fabricated as one or more thin films in order to form the controllable modulating components. While lithium niobate (LiNbO₃) has excellent low-loss and high-transparency properties, lithium niobate has an electro-optical (EO) coefficient of around 30 pm/V, which can limit its use in larger “bulk” applications. Ferroelectric and dielectric ceramics can have low insertion losses (such as less than about 1 dB/cm) while having EO coefficients that are significantly higher than lithium niobate (such as more than one hundred times higher). Thus, the use of ferroelectric and dielectric ceramics in the controllable modulating components can support higher data modulation rates while still achieving low insertion losses. Note, however, that some embodiments of the modulating retroreflectors 200a-200c, 300a-300c may be fabricated using lithium niobate for one or more of the controllable modulating components.

Materials with higher EO coefficients can allow larger phase changes or other modulations to be achieved using lower control voltages. For example, since power is proportional to voltage squared, a 50% reduction in the voltage requirement would result in a 75% reduction in the power requirement. Note that each modulating retroreflector 200a-200c, 300a-300c includes multiple controllable modulating components coupled in series. A control voltage would be applied to the multiple modulating components in series rather than a single modulating component as in some retroreflectors, so the voltage across each individual modulating component would be smaller. However, the total overall voltage that is used for all modulating components may still be maintained at the same or similar level since the desired optical phase shifts or other modulations are also divided among the multiple modulating components. Thus, as an example, assume the phase shift imparted by each modulating component is linearly dependent on the applied voltage. In that case, using two modulating components may involve each modulating component receiving 50% of the voltage needed to provide the same modulation as a single modulating component, or using four modulating components may involve each modulating component receiving 25% of the voltage needed to provide the same modulation as a single modulating component. This can also spread thermal energy across a larger surface area in each modulating retroreflector 200a-200c, 300a-300c, which can help to reduce thermal issues and simplify thermal management.

These designs for modulating retroreflectors 200a-200c, 300a-300c can achieve significantly higher data rates and/or significantly higher ranges compared to prior approaches. For example, by selecting suitable materials and designs for a modulating retroreflector, it is possible to scale the modulating retroreflector up to speeds of one gigabaud or higher. Replicating the modulating retroreflector into an array or conformal antenna (which may include a large number of modulating retroreflectors operating in parallel) can be used to achieve even higher data rates, such as up to one hundred gigabaud or higher. Also or alternatively, equivalent or increased speeds may be obtained over larger distances, such as up to ten kilometers or more. In some cases, this can be achieved by providing larger apertures (such as those up to one centimeter or more in diameter) and larger combined surface areas that can be used for providing optical signal modulations. Depending on which prior approach forms the basis for comparison, this may represent up to a fifty-times increase in data rate and a ten-times increase in range (although these increases vary based on the actual design of the modulating retroreflector 200a-200c, 300a-300c and based on the prior approach forming the baseline). Further, the modulating retroreflectors 200a-200c, 300a-300c can be used to perform modulations over very broad operating wavelength ranges, such as wavelength ranges spanning about 800 nanometers (compared to 30 nanometers). Moreover, since each of the modulating retroreflectors 200a-200c, 300a-300c includes multiple controllable modulating components, it is possible to provide multilevel phase modulations or other multilevel modulations, which can support increased spectral efficiencies. In addition, the modulating retroreflectors 200a-200c, 300a-300c can have compact packages while providing larger apertures and while using significantly less power (such as less than one watt of radio frequency power), which can provide significant size, weight, power, and cost reductions.

Although FIGS. 2A through 2C illustrate examples of corner-cube modulating retroreflectors 200a-200c and FIGS. 3A through 3C illustrate examples of cat's eye modulating retroreflectors 300a-300c having series-coupled modulating components, various changes may be made to FIGS. 2A through 3C. For example, the actual arrangement of reflective and transmissive surfaces and structures and other optical components forming each modulating retroreflector can vary from the arrangements shown here, as long as the optical components can be used to reflect light in the same or similar direction at which the light is received. Also, each of the controllable modulating components in each modulating retroreflector 200a-200c, 300a-300c may represent any suitable standalone component or a component fabricated on or in association with another component of the modulating retroreflector.

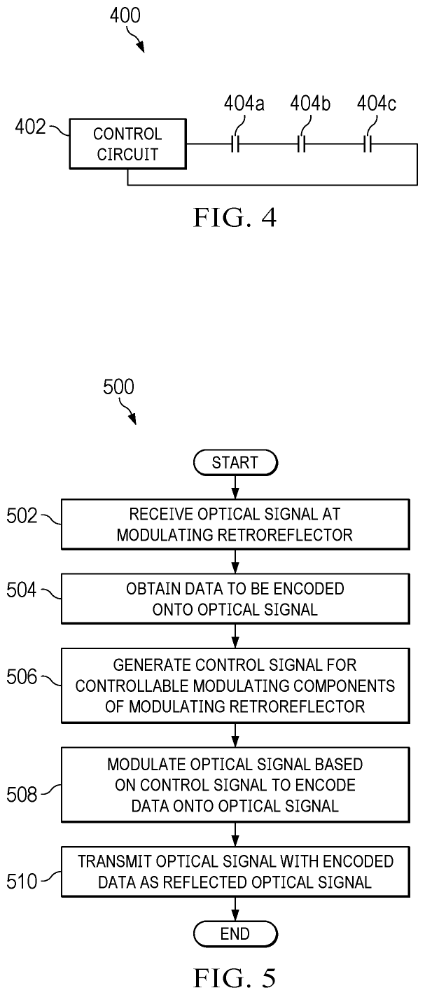

FIG. 4 illustrates an example arrangement 400 for controlling a modulating retroreflector having series-coupled modulating components according to this disclosure. For case of explanation, the arrangement 400 shown in FIG. 4 is described as being used in conjunction with any of the modulating retroreflectors 110, 200a-200c, 300a-300c described above. However, the arrangement 400 shown in FIG. 4 may be used with any other suitable modulating retroreflector having series-coupled modulating components designed in accordance with this disclosure.

As shown in FIG. 4, the arrangement 400 includes a control circuit 402 that is electrically coupled in series with multiple capacitors 404a-404c. In this example, each capacitor 404a-404c represents one of the controllable modulating components of a modulating retroreflector 110, 200a-200c, 300a-300c. Thus, for instance, each capacitor 404a-404c may represent a reflective surface 202, 204, 208, 306 or a layer 206, 308a, 308b, 308c of material that is controllable in order to impart modulations to optical signals. Note that while three capacitors 404a-404c are shown here as representing three controllable modulating components of a modulating retroreflector 110, 200a-200c, 300a-300c, the modulating retroreflector may include two controllable modulating components or more than three controllable modulating components.

The control circuit 402 generally operates to produce an electrical signal that is provided to the controllable modulating components represented by the capacitors 404a-404c in order to control the optical signal modulations provided by the controllable modulating components. For example, the control circuit 402 may generate an electrical signal having pulses that control the amount of phase modulations or other modulations provided by the controllable modulating components. As a particular example, the control circuit 402 may generate an electrical signal having longer or more numerous pulses to increase the amount of phase modulations or other modulations provided by the controllable modulating components and shorter or less numerous pulses to decrease the amount of phase modulations or other modulations provided by the controllable modulating components.

The control circuit 402 represents any suitable structure configured to control phase, amplitude, intensity, polarization, or other modulations provided by controllable modulating components. In some embodiments, the control circuit 402 may include one or more microprocessors, microcontrollers, digital signal processors (DSPs), application specific integrated circuits (ASICs), field programmable gate arrays (FPGAs), or discrete circuitry. In particular embodiments, the control circuit 402 may implement or represent a pulse width modulation (PWM) controller.

As can be seen here, the controllable modulating components of a modulating retroreflector 110, 200a-200c, 300a-300c represented by the capacitors 404a-404c are electrically coupled in series, so each capacitor 404a-404c (and therefore each corresponding modulating component) is electrically coupled in series with a preceding modulating component, a subsequent modulating component, or both. Since each of the controllable modulating components has an associated capacitance and the controllable modulating components are coupled in series, the total capacitance of the controllable modulating components decreases compared to the individual capacitances of the modulating components. This is due to the well-known series capacitance rule that defines the total capacitance Cₜₒₜₐₗ of multiple series-coupled capacitors as follows.

$$\frac{1}{{C}_{total}} = \frac{1}{{C}_{1}} + \frac{1}{{C}_{2}} + \frac{1}{{C}_{3}} + …$$

For a standard capacitor formed using two equally-sized conductive plates separated by a dielectric, the capacitance of the capacitor may be defined as follows.

$$C = ε \frac{A}{d}$$

Here, ε represents the permittivity of the dielectric, A represents the area of each conductive plate, and d represents the separation or distance between the conductive plates. As can be seen here, the capacitance of the capacitor is proportional to the area of the capacitor. In the context of a single circular reflective surface having a diameter r, the baseline area A of the reflective surface is defined as follows.

A=πr²

Taking the modulating retroreflector 200a shown in FIG. 2A as an example, the modulating retroreflector 200a can have three reflective surfaces 202 each spanning a 120° portion of the cross-section of the modulating retroreflector 200a. If each of the three reflective surfaces 202 is elevated at an angle of 35° relative to a plane under the reflective surfaces 202, the area A_{I} of each individual reflective surface 202 may be defined as follows.

$${A}_{I} \approx \frac{3}{4} π {r}^{2}$$

If the capacitance of the single circular reflective surface is denoted as C, the capacitance of each of the three reflective surfaces 202 may have a value of approximately ¾C. The total capacitance of the series-coupled reflective surfaces 202 would therefore be calculated as (¾C)/n, where n represents the number of reflective surfaces 202 (so n=3 in the example of FIG. 2A). As a result, the total capacitance of the series-coupled reflective surfaces 202 is reduced by more than a factor of n, which can similarly result in an increase in the data rate of the modulating retroreflector 200a. Moreover, this can be achieved without requiring a corresponding n-fold increase in the power required by the modulating retroreflector 200a. Also or alternatively, larger modulators having their capacitances coupled in series may be used, possibly achieving the same or similar overall capacitance as the single circular reflective surface. As a result, this may allow an increase in the aperture size or range of the modulating retroreflector 200a. Note that other reductions or changes in capacitance can be calculated for any of the modulating retroreflectors described above and for other designs of the modulating retroreflector 200a.

Although FIG. 4 illustrates one example of an arrangement 400 for controlling a modulating retroreflector having series-coupled modulating components, various changes may be made to FIG. 4. For example, there may be multiple control circuits 402 configured to control different controllable modulating components or different combinations of controllable modulating components in a modulating retroreflector. Also, there is no requirement that every control circuit 402 be coupled to multiple series-coupled modulating components.

FIG. 5 illustrates an example method 500 for using a modulating retroreflector having series-coupled modulating components according to this disclosure. For case of explanation, the method 500 shown in FIG. 5 is described as being performed using any of the modulating retroreflectors 110, 200a-200c, 300a-300c described above, which may be used in the optical system 100 of FIG. 1. However, the method 500 shown in FIG. 5 may be performed using any other suitable modulating retroreflector having series-coupled modulating components designed in accordance with this disclosure and in any other suitable system.

As shown in FIG. 5, an optical signal is received at a modulating retroreflector at step 502. This may include, for example, the modulating retroreflector 110, 200a-200c, 300a-300c of the node 104 receiving an optical signal 108 transmitted by the optical transmitter 106 of the node 102. Data to be encoded onto the optical signal is obtained at step 504. This may include, for example, the control circuit 402 or other component of the node 104 retrieving data from a memory, generating data, or otherwise obtaining data to be encoded onto the optical signal 108. A control signal for multiple controllable modulating components of the modulating retroreflector is generated at step 506. This may include, for example, the control circuit 402 generating a control signal containing pulses, where the number, size, and/or other characteristic(s) of the pulses can be controlled based on the data to be encoded onto the optical signal 108.

The optical signal is modulated based on the control signal in order to encode the data onto the optical signal at step 508. This may include, for example, one or more of the reflective surfaces 202, 204, 208, 306 and/or one or more of the layers 206, 308a-308c of the modulating retroreflector imparting phase, amplitude, intensity, polarization, or other modulations to the optical signal 108 based on the control signal from the control circuit 402. The encoded optical signal is transmitted from the modulating retroreflector as a reflected optical signal at step 510. This may include, for example, the modulating retroreflector providing the modulated optical signal 108 as the reflected optical signal 112, which can be sent back in the same or similar direction that the optical signal 108 was received. The node 102 can therefore receive the reflected optical signal 112 using the optical receiver 114 and decode the modulations contained in the reflected optical signal 112 in order to recover the data encoded by the node 104 onto the reflected optical signal 112.

Although FIG. 5 illustrates one example of a method 500 for using a modulating retroreflector having series-coupled modulating components, various changes may be made to FIG. 5. For example, while shown as a series of steps, various steps in FIG. 5 may overlap, occur in parallel, occur in a different order, or occur any number of times.

The following describes example embodiments of this disclosure that implement or relate to a modulating retroreflector having series-coupled modulating components. However, other embodiments may be used in accordance with the teachings of this disclosure.

In a first embodiment, an apparatus includes a modulating retroreflector. The modulating retroreflector includes one or more reflective surfaces configured to receive an optical signal and to provide a reflected optical signal. The modulating retroreflector also includes multiple modulators configured to modulate the optical signal and encode data onto the optical signal such that the reflected optical signal represents a reflected and modulated version of the optical signal. The multiple modulators are electrically connected in series.

In a second embodiment, a system includes a modulating retroreflector. The modulating retroreflector includes one or more reflective surfaces configured to receive an optical signal and to provide a reflected optical signal. The modulating retroreflector also includes multiple modulators configured to modulate the optical signal and encode data onto the optical signal such that the reflected optical signal represents a reflected and modulated version of the optical signal. The multiple modulators are electrically connected in series. The system also includes a control circuit configured to generate a drive signal and to provide the drive signal to the multiple modulators in order to control the encoding of the data onto the optical signal.

In a third embodiment, a method includes receiving an optical signal at a modulating retroreflector. The method also includes reflecting the optical signal using the modulating retroreflector, where the modulating retroreflector includes one or more reflective surfaces configured to receive the optical signal and to provide a reflected optical signal. The method further includes encoding data onto the optical signal, where the modulating retroreflector further includes multiple modulators configured to modulate the optical signal and encode the data onto the optical signal such that the reflected optical signal represents a reflected and modulated version of the optical signal. The multiple modulators are electrically connected in series.

Any single one or any suitable combination of the following features may be used with the first, second, or third embodiment. The multiple modulators may include two or more reflective surfaces of the modulating retroreflector. The multiple modulators may include two or more layers of optically-transparent material positioned in front of or within the modulating retroreflector. The multiple modulators may include at least one of the one or more reflective surfaces of the modulating retroreflector and one or more layers of optically-transparent material positioned in front of or within the modulating retroreflector. The multiple modulators may include at least one of: a ferroelectric ceramic and a dielectric ceramic. The multiple modulators may include at least one of: lead lanthanum zirconate titanate (PLZT) and barium titanium (BaTi). The multiple modulators may be configured to provide at least one of: phase modulations, amplitude modulations, intensity modulations, and polarization modulations to the optical signal in order to encode the data onto the optical signal. Different ones of the multiple modulators may be configured to provide different types of modulations to the optical signal in order to perform multilevel modulations of the optical signal. The modulating retroreflector may include a corner-cube modulating retroreflector or a cat's eye modulating retroreflector.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a modulating retroreflector comprising one or more reflective surfaces, the one or more reflective surfaces configured to receive an optical signal and to provide a reflected optical signal;
the modulating retroreflector further comprising multiple modulators configured to modulate the optical signal and encode data onto the optical signal such that the reflected optical signal represents a reflected and modulated version of the optical signal;
wherein the multiple modulators are electrically connected in series.

2. The apparatus of claim 1, wherein the multiple modulators comprise two or more reflective surfaces of the modulating retroreflector.

3. The apparatus of claim 1, wherein the multiple modulators comprise two or more layers of optically-transparent material positioned in front of or within the modulating retroreflector.

4. The apparatus of claim 1, wherein the multiple modulators comprise:
at least one of the one or more reflective surfaces of the modulating retroreflector; and
one or more layers of optically-transparent material positioned in front of or within the modulating retroreflector.

5. The apparatus of claim 1, wherein the multiple modulators comprise at least one of: a ferroelectric ceramic and a dielectric ceramic.

6. The apparatus of claim 1, wherein the multiple modulators comprise at least one of: lead lanthanum zirconate titanate (PLZT) and barium titanium (BaTi).

7. The apparatus of claim 1, wherein the multiple modulators are configured to provide at least one of: phase modulations, amplitude modulations, intensity modulations, and polarization modulations to the optical signal in order to encode the data onto the optical signal.

8. The apparatus of claim 1, wherein different ones of the multiple modulators are configured to provide different types of modulations to the optical signal in order to perform multilevel modulations of the optical signal.

9. The apparatus of claim 1, wherein the modulating retroreflector comprises a corner-cube modulating retroreflector or a cat's eye modulating retroreflector.

10. A system comprising:
a modulating retroreflector comprising:
one or more reflective surfaces, the one or more reflective surfaces configured to receive an optical signal and to provide a reflected optical signal; and
multiple modulators configured to modulate the optical signal and encode data onto the optical signal such that the reflected optical signal represents a reflected and modulated version of the optical signal, wherein the multiple modulators are electrically connected in series; and
a control circuit configured to generate a drive signal and to provide the drive signal to the multiple modulators in order to control the encoding of the data onto the optical signal.

11. The system of claim 10, wherein the multiple modulators comprise two or more reflective surfaces of the modulating retroreflector.

12. The system of claim 10, wherein the multiple modulators comprise two or more layers of optically-transparent material positioned in front of or within the modulating retroreflector.

13. The system of claim 10, wherein the multiple modulators comprise:
at least one of the one or more reflective surfaces of the modulating retroreflector; and
one or more layers of optically-transparent material positioned in front of or within the modulating retroreflector.

14. The system of claim 10, wherein the multiple modulators comprise at least one of: a ferroelectric ceramic and a dielectric ceramic.

15. The system of claim 10, wherein the multiple modulators comprise at least one of: lead lanthanum zirconate titanate (PLZT) and barium titanium (BaTi).

16. The system of claim 10, wherein the multiple modulators are configured to provide at least one of: phase modulations, amplitude modulations, intensity modulations, and polarization modulations to the optical signal in order to encode the data onto the optical signal.

17. The system of claim 10, wherein different ones of the multiple modulators are configured to provide different types of modulations to the optical signal in order to perform multilevel modulations of the optical signal.

18. The system of claim 10, wherein the modulating retroreflector comprises a corner-cube modulating retroreflector or a cat's eye modulating retroreflector.

19. A method comprising:
receiving an optical signal at a modulating retroreflector;
reflecting the optical signal using the modulating retroreflector, the modulating retroreflector comprising one or more reflective surfaces configured to receive the optical signal and to provide a reflected optical signal; and
encoding data onto the optical signal, the modulating retroreflector further comprising multiple modulators configured to modulate the optical signal and encode the data onto the optical signal such that the reflected optical signal represents a reflected and modulated version of the optical signal, wherein the multiple modulators are electrically connected in series.

20. The method of claim 19, wherein the modulating retroreflector comprises a corner-cube modulating retroreflector or a cat's eye modulating retroreflector.
